(19) United States
(12) Patent Application Publication
(10) Pub. No.: US 2009/0246570 A1
(43) Pub. Date: Oct. 1, 2009

(54) METHOD AND APPARATUS FOR MEASURING CROSSOVER LOSS OF FUEL CELL

(76) Inventors: Takayuki Hirashige, Hitachi (JP); Tomoichi Kamo, Tokai (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/280,008

(22) PCT Filed: Mar. 28, 2006
(86) PCT No.: PCT/JP2006/307023

§ 371 Date: Feb. 6, 2009

(51) Int. Cl. H01M 8/04; H01M 8/10

(52) U.S. Cl. 429/17; 429/22; 429/30

(57) ABSTRACT

When using a measurement of a crossover current density by the Gotesfeld method or a measurement of a methanol permeation coefficient by gas chromatography or by liquid chromatography, a measure for crossover amount may be given but the interrelation with a crossover loss is not clearly known and thus, it could not be possible to evaluate a degree of the crossover loss. The present invention has for its object the provision of a novel measuring method that is able to measure a methanol crossover loss directly.

The measuring method is characterized by measuring a crossover loss of MEA for methanol fuel cell from a difference between a voltage when a cathode catalyst layer is not influenced by methanol crossover and a voltage when the cathode catalyst layer is influenced by the methanol crossover.

### TECHNICAL FIELD

This invention relates to a novel method for measuring a crossover loss relative to a membrane electrode assembly for fuel cells. The invention also relates to a measuring apparatus based on the measuring method. The invention still relates to various type of application devices based on the measuring method.

### TECHNICAL BACKGROUND

In recent years, a direct methanol fuel cell DMFC (Direct Methanol Fuel Cell) using methanol as a fuel has been expected as an electric source for portable devices in place of lithium ion secondary cells, and extensive developments have been made in order to work forward the practical use thereof.

The electric generation unit of DMFC has a structure wherein a cathode catalyst layer and an anode catalyst layer are provided on opposite sides of a proton conductive solid polymer electrolyte membrane. This is called membrane electrode assembly (Membrane Electrode Assembly). The cathode catalyst layer and the anode catalyst layer are each made of a matrix wherein catalyst-supporting carbon and a solid polymer electrolyte are appropriately mixed together, and the electrode reaction is carried out at the three-phase interface where the catalyst on carbon, the solid polymer electrode and a reactant are in contact with one another. Carbon linkage is a path of electrons and solid polymer electrolyte linkage becomes a path of protons.

DMFC is such that reactions of the formulas (1) and (2), respectively, occur at the anode catalyst layer and the cathode catalyst layer and electricity is taken out

CH₃OH+H₂O→CO₂+6H⁺+6e⁻ (1)

O₂+4H⁺+4e^{u-}→2H₂O (2)

The total reaction formula combining (1) and (2) is as follows

CH₃OH+3/2O₂→CO₂+H₂O (3)

It has been accepted that DMFC has an energy density of about 10 times greater than lithium secondary cells theoretically. At present, however, the output of MEA is lower than that of a lithium secondary cell, thus not yet arriving at practice.

For improving the output of MEA, there are approaches for improving catalysts and an electrolyte membrane and optimizing an MEA structure. Of these, an improvement in electrolyte membrane is a key for improving the output of MEA. The properties required for the electrolyte membrane are those two including (1) high proton conductivity and (2) a low pervious amount of methanol. The proton conductivity of (1) relates to a resistance of the electrolyte membrane. If the proton conductivity is low, the resistance increases, thereby inviting an output lowering. The pervious amount of methanol of (2) is concerned with so-called “crossover” wherein methanol at the anode arrives at the cathode after passage through the electrolyte membrane. The methanol arriving at the cathode reacts with oxygen on the cathode catalyst chemically, thereby generating heat. This causes an overvoltage to be increased at the cathode owing to the crossover, thereby lowering the output of MEA. A lowering of output voltage caused by the crossover is called “crossover loss”.

Methods of measuring an amount of crossover includes (i) a measurement of a transmitted current density (J. Electrochem. Soc., 147 (2) 466, (2000)) by the Gotesfeld method, (ii) a measurement of a coefficient of methanol permeability by gas chromatography, (iii) a measurement of a coefficient of methanol permeability by liquid chromatography, and the like.

According to the method (i), because the electrode reaction differs from the electrode reaction of DMFC, the crossover loss which is a lowering of output voltage of MEA cannot be estimated. More particularly, an electric current of a reaction differing from an actual DMFC reaction formula is measured.

With (ii) and (iii), judging from a membrane thickness and a time, a coefficient of methanol permeability is calculated to compare the crossover amounts of methanol with each other.

Although the methanol crossover current and the coefficient of methanol permeability become a measure for a crossover amount, interrelation with the crossover loss is not clear, so that it cannot be estimated how much is a crossover loss.

In this way, although a crossover loss is a factor that is important for determining an output in actual fuel cells, the method of direct measurement has never been known up to now and thus, other crossover amounts are used for a measure. It is unclear what meaning is involved in the measured crossover current density or a permeability coefficient. For instance, if these values are reduced to ½, a crossover loss is not reduced to ½.

### DISCLOSURE OF THE INVENTION

In view of the above, the present invention has for its object the provision of a novel measuring method of measuring a methanol crossover loss directly.

The measuring method for evaluating a crossover amount of methanol of the membrane electrode assembly by measuring a voltage of a membrane electrode assembly which comprises a cathode catalyst layer reducing an oxidative gas and an anode catalyst layer oxidizing a methanol aqueous solution, a proton conductive solid polymer electrolyte membrane layer arranged therebetween.

### BRIEF DESCRIPTION OF THE DRAWINGS

FIG. 1 is a view showing a flowchart of a measuring method according to the invention,

FIG. 2 is a view showing a graph of a voltage change according to the invention,

FIG. 3 is a view showing a measuring apparatus according to the invention,

FIGS. 4 to 6 are, respectively, a view showing a fuel cell according to the invention, and

FIGS. 7 to 14 are, respectively, graphs showing embodiments or comparative examples related to the invention.

### BEST MODE FOR CARRYING OUT THE INVENTION

Embodiments of the invention are described in detail with reference to the drawings.

This embodiment is directed to a measuring method, characterized in that a crossover loss is measured from a difference between a voltage at which a cathode catalyst layer is free of an influence of methanol crossover and a voltage at which the cathode catalyst layer receives an influence of methanol crossover relative to MEA for methanol fuel cell.

In order to measure a voltage at which no influence of methanol crossover is received, it is characterized that a methanol aqueous solution is filled in an anode and an inert gas is filled in a cathode, under which a voltage is loaded between the anode and the cathode, thereby oxidizing the methanol crossovered from the anode to the cathode electrochemically. Thereafter, the measuring method is characterized in that air or oxygen is subsequently fed to the cathode to measure a variation of an open circuit voltage OCV (Open Circuit Voltage). In this measuring method, a maximum voltage measured immediately after the feed of air or oxygen in the cathode is a voltage at which methanol is substantially zero in the cathode catalyst layer, i.e. a voltage at which no influence of methanol crossover is received. If allowing to stand as it is, the cathode catalyst layer turns to a voltage, at which an influence of methanol crossover is received, with the voltage becoming constant. The difference between these voltages corresponds to a crossover loss. This embodiment is also directed to a measuring apparatus based on the above-stated measuring principle and is able to measure a crossover loss directly.

The voltage at which the cathode catalyst layer does not receive any influence of methanol crossover means a voltage in a state where a methanol aqueous solution in the cathode catalyst layer is ideally at 0 or is close to 0. The voltage at which the cathode catalyst layer receives an influence of methanol crossover means a voltage that becomes constant at a given value as a result that methanol is crossovered from the anode to the cathode, so that an overvoltage of the cathode becomes great to lower an output voltage.

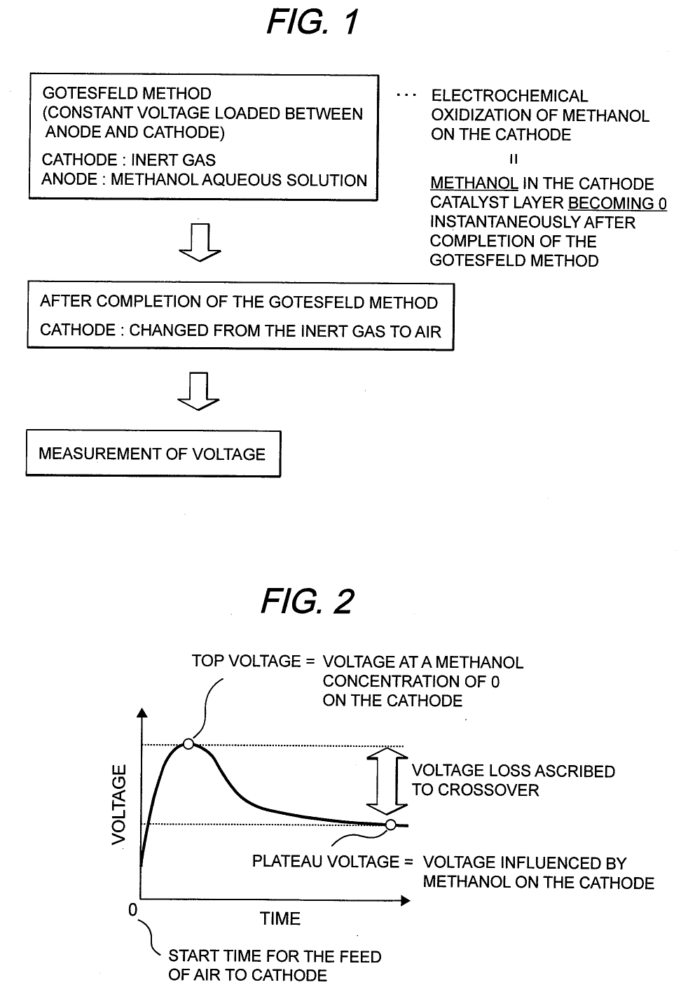

FIG. 1 shows a flowchart of a novel measuring method of a methanol crossover loss according to this embodiment. Initially, in the novel methanol crossover loss measuring method, measurement by the Gotesfeld method is carried out. More particularly, an inert gas is fed to a cathode side and a methanol aqueous solution is filled at an anode side, under which a voltage is loaded between the anode and cathode. In the novel crossover loss measuring method of this embodiment, attention has been paid to the fact that immediately after the Gotesfeld method, methanol in the cathode catalyst layer instantaneously becomes substantially 0. That is, in the Gotesfeld method, the methanol aqueous solution in the cathode catalyst layer is consumed by electrochemical reaction. As shown in the flowchart of FIG. 1, when an open circuit voltage OCV (Open Circuit Voltage) is measured, in this state, after feed of air or oxygen to the cathode in place of the inert gas, a maximum voltage is measured immediately after the feed of air or oxygen. This voltage is a voltage corresponding to a state where the methanol aqueous solution in the cathode catalyst layer is substantially at 0. (This voltage is defined as top voltage.) When keeping the state as it is, the methanol in the anode permeates to the cathode and a voltage becomes constant after a given time. (This constant voltage is defined as a plateau voltage.) This constant voltage is a voltage at which the methanol is crossovered from the anode toward the cathode and the cathode catalyst layer receives an influence of the methanol. As shown in FIG. 2, a difference between the top voltage and the plateau voltage corresponds to crossover loss.

In practice, where a methanol concentration is high, the top voltage measured is not a voltage at which the methanol in the cathode catalyst layer is not exactly at 0. More particularly, it is considered that if the methanol concentration is high, the methanol aqueous solution is left on the carbon surfaces or fine pores of the catalyst carrier immediately after the Gotesfeld method. Methanol is present in the electrolyte membrane. It is considered that these methanol aqueous solutions instantaneously influence the voltage upon completion of the Gotesfeld method. In this sense, it is preferred that the methanol concentration is as low as possible when the top voltage is measured. More particularly, the concentration is preferably not larger than 1 wt %. More preferably, the concentration is not larger than 0.5 wt %.

In the novel crossover loss measuring method of this embodiment, a difference between the top voltage and the plateau voltage corresponds to a crossover loss. If the methanol concentrations differ from each other for the measurements of the top voltage and the plateau voltage, correction will be necessary. In other words, the difference in methanol concentration causes a variation in anode potential, for which correction is necessary. For the correction, the Nernst equation can be used. The equilibrium electromotive force E of the equation (3) is expressed from the Nernst equation as follows.

E=E₀+2.303×(RT/nF) log [a_{CH3OH}×P₀₂^{3/2}/a_{H2O2}×P_{CO2}] (6)

(E₀: theoretical electromotive force, a: activity and P: partial pressure).

Where a methanol concentration at the time of measurement of top voltage is taken as wt (wt %) and a methanol concentration at the time of measurement of plateau voltage is as wp (wt %), a voltage difference ΔV_{conc.} ascribed to the difference in the methanol concentration is expressed as follows when taking the Nernst equation is taken into account

ΔV_{conc.}=E_{wp}−E_{wt}=2.303×(RT/nF) log [a_{CH3OH, wp}/a_{CH3OH, wt}](E_{wp}: voltage at wp, E_{wt}: voltage at wt, a_{CH3OH, wp}: activity at wp, and a_{CH3OH, wt}: activity at wt.)=0.01×log (wp/wt) (7)

Taking the above into consideration, the methanol crossover loss ΔV_{crossover loss} can be obtained according to the following equation

ΔV_{crossover loss}=E_{wt}^{t}−E_{wp}^{p}+ΔV_{conc.} (8)

(E_{wt}^{t}: top voltage at wt, and E_{wp}^{p}: plateau voltage at wp).

In the Gotesfeld method, if a voltage loaded between the anode and cathode is too low, a current to be measured is such that the crossover of methanol from the anode side to the cathode side of MEA is not rate limited, but the reaction of (4) or (5) in the catalyst layer is rate limited. Accordingly, a current to be measured does not correspond to “crossover current”. The voltage loaded between the anode and cathode is preferably 0.7V or more. If the voltage loaded between the anode and the cathode is too high, electrolysis of an electrolyte and water takes place. To avoid this, the voltage is preferably at 0.9V or less.

The time of applying a voltage between the anode and the cathode is until a crossover current value to be measured becomes constant and is preferably 1 minute to 2 hours.

For the type of inert gas fed according to the Gotesfeld method, there can be used nitrogen gas, argon gas, helium gas and the like. The flow rate may be one which allows the gas to be passed throughout the cathode and is preferably 10-1000 ml/minute. Immediately after the Gotesfeld method, the flow rate of air or oxygen being fed is preferably 10-1000 ml/minute. In addition, the cathode may be opened immediately after the Gotesfeld method, followed by subjecting to natural expiration of air to measure an open circuit voltage OCV.

In this embodiment, after the Gotesfeld method, although air or oxygen is fed to the cathode to measure an open circuit voltage OCV, the measuring time varies depending on the MEA conditions such as, for example, an amount of catalyst, a thickness of the catalyst layer and a type of electrolyte membrane. The measuring time before arriving at a plateau voltage is preferably 2 minutes to 10 hours. Moreover, if a plateau voltage can be calculated by extrapolation of a voltage change, the measuring time may be shortened.

As a method of feeding a methanol aqueous solution to the anode, there may be used a tank system wherein a given amount of a methanol aqueous solution is filled or a flow system wherein a methanol aqueous solution is passed at a given flow rate. With the flow system, the flow rate of the methanol aqueous solution is preferably 5-500 ml/minute.

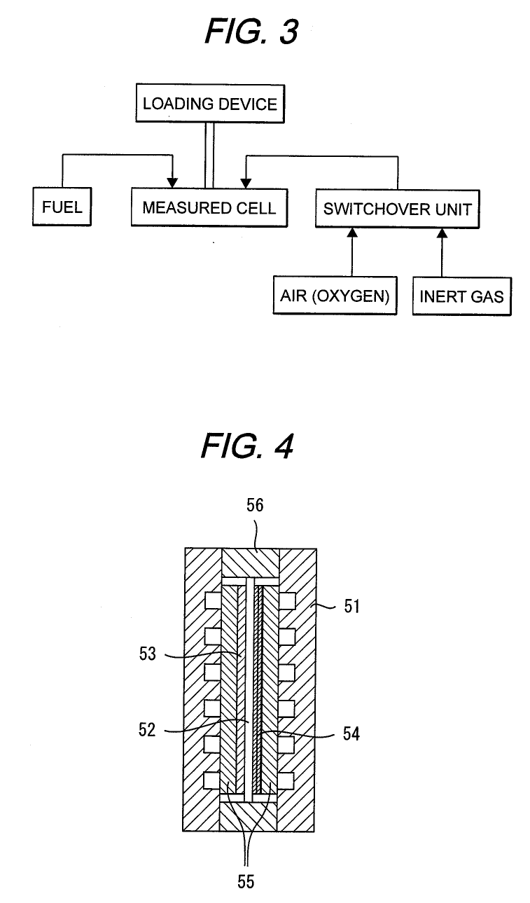

In FIG. 3, there is shown a novel methanol crossover loss measuring apparatus according to this embodiment. The apparatus is provided with a device capable of feeding an inert gas and air or oxygen to the cathode side by switching one from the other, a device capable of feeding a methanol aqueous solution to the anode side as a fuel, and a device capable of loading a voltage between the anode and the cathode. The apparatus is such that when a voltage is loaded in such a state where an inert gas is filled in the cathode, the methanol crossovered toward the cathode side is oxidized electrochemically, followed by feeding air or oxygen to the cathode side in place of the inert gas to measure an open circuit voltage OCV. The apparatus is able to calculate a methanol crossover loss from a difference between the measured top voltage and plateau voltage. Preferably, there is provided a device for calculating a correction based on the difference in methanol concentration automatically when measuring a top voltage and a plateau voltage. Preferably, there is provided a control device of sensing automatically that methanol in the cathode catalyst layer becomes 0 and supplying air or oxygen to the cathode side in place of the inert gas. In addition, there is preferably provided a device of calculating a plateau voltage by extrapolation of a voltage change in the measurement of plateau voltage.

A measuring cell is not limited critically. For instance, there can be used a single cell as shown in FIG. 4. In FIG. 4, indicated by 51 is a separator, by 52 is an electrolyte membrane, by 53 is an anode catalyst layer, by 54 is a cathode catalyst layer, by 55 is a diffusion layer, and by 56 is a gasket. MEA is one wherein the anode catalyst layer 53 and the cathode catalyst layer 54 are bonded to the electrolyte membrane 52. The separator 51 is conductive and a material therefor is preferably made of a dense graphite plate, a carbon plate wherein a carbon material such as graphite or carbon black is shaped by means of a resin, or a metal material having an excellent corrosion resistance such as a stainless steel, titanium or the like. It is preferred that the separator 51 may be plated on the surface thereof with a noble metal or is coated with a conductive paint having excellent corrosion and heat resistances for surface treatment. The separator 51 is trenched at portions in contact with the anode catalyst layer 53 and the cathode catalyst layer 54, through which a methanol aqueous solution serving as a fuel is fed at the anode side and an inert gas and air or oxygen is fed at the cathode side.

This embodiment can be used for PEFC (Polymer Electrolyte Fuel Cell) using hydrogen as a fuel. With PEFC and DMFC, H⁺ that is produced by electrode reaction in the anode catalyst layer moves from the anode catalyst layer toward cathode catalyst layer in the electrode membrane, and water entrained with H⁺ also moves in the electrolyte membrane. With DMFC, methanol used as a fuel has the same size as water and is compatible therewith, thereby permitting passage through the electrolyte membrane. On the other hand, with PEFC, hydrogen gas is, more or less, dissolved in water, so that crossover takes place as water moves. Crossover also occurs through fine pores in the electrolyte membrane. Like DMFC, a crossover loss is caused wherein crossovered hydrogen increases an overvoltage at the cathode, thereby lowering an output voltage.

This embodiment can be used to measure a hydrogen crossover loss against PEFC. For the measurement of a hydrogen crossover loss, measurement by the Getesfeld method is carried out. More particularly, hydrogen gas is fed to an anode and an inert gas is fed to a cathode, under which a given voltage is loaded between the anode and the cathode. For the reaction formula, the crossovered hydrogen gas from the anode side undergoes the following reaction at the cathode side.

H₂→2H⁺+2e⁻ (9)

The resulting proton H⁺ undergoes the following reaction at the anode side.

2H⁺+2e⁻→H₂ (10)

Like DMFC, immediately after the Gotesfeld method, hydrogen in the cathode catalyst layer instantaneously becomes substantially 0. More particularly, according to the Gotesfeld method, hydrogen in the cathode catalyst layer is consumed by electrochemical reaction. Like the flowchart of FIG. 1, when the open circuit voltage OCV is measured by feeding air or oxygen to the cathode in this condition in place of the inert gas, a maximum voltage is measured immediately after the feed of air or oxygen. This voltage corresponds to a voltage in a state where a methanol aqueous solution in the cathode catalyst layer is substantially at 0. (This voltage is defined as top voltage.) When the system is kept as it is, hydrogen at the anode passes to the cathode and the voltage becomes constant after a lapse of a given time. (This constant voltage is defined as plateau voltage.) Like FIG. 2, a difference between the top voltage and the plateau voltage corresponds to a crossover loss of hydrogen.

This embodiment relates to a measuring apparatus based on the principle of the novel hydrogen crossover measuring method. In FIG. 3, there is shown a novel hydrogen crossover loss measuring apparatus. The apparatus comprises a device capable of feeding an inert gas and air or oxygen to a cathode side by switching from one to another, a device capable of feeding hydrogen gas as a fuel to an anode side, and a device capable of loading a voltage between the anode and the cathode. The apparatus is so arranged that a voltage is loaded on the cathode in a state where the inert gas is filled and hydrogen crossovered at the cathode side is oxidized electrochemically, after which air or oxygen is fed to the cathode side in place of the inert gas to measure a change of an open circuit voltage OCV. The apparatus is able to calculate a hydrogen crossover loss from a difference between the measured top voltage and plateau voltage. The apparatus is preferably provided with a control device of sensing automatically that hydrogen at the cathode is at 0 and feeding air or oxygen to the cathode side in place of the inert gas. In addition, the apparatus is preferably provided with a device of calculating a plateau voltage by extrapolation of the voltage change in the measurement of the plateau voltage.

If the principle of the crossover loss measurement of this embodiment is applied to, there can be obtained a simpler measuring method although not so accurate. In the crossover loss measurement of the embodiment, an inert gas is filled in the cathode and a voltage is loaded between the anode and the cathode. However, the feed of an inert gas needs a complicated device and a prolonged time, and measurement becomes impossible when using a so-called passive DMFC cell wherein a cathode is not subjected to forced inspiration. To avoid this, it may occur that instead of filling the cathode with an inert gas, a constant current is loaded thereby lowering an oxygen concentration on and in the surface of a cathode catalyst layer. More particularly, the loading of a current causes the DMFC cell reaction of the formula (2) to occur at the cathode and thus, oxygen is consumed, thereby lowering an oxygen concentration on or in the surface of the cathode catalyst layer. Thereafter, a voltage is loaded between the anode and the cathode, so that methanol crossovered from the anode toward the cathode is oxidized electrochemically to cause the methanol in the cathode catalyst layer to be reduced substantially to 0. Subsequently, air or oxygen is fed to the cathode and a variation of an open circuit voltage OCV thereof is measured to measure a top voltage and a plateau voltage thereby obtaining a crossover loss.

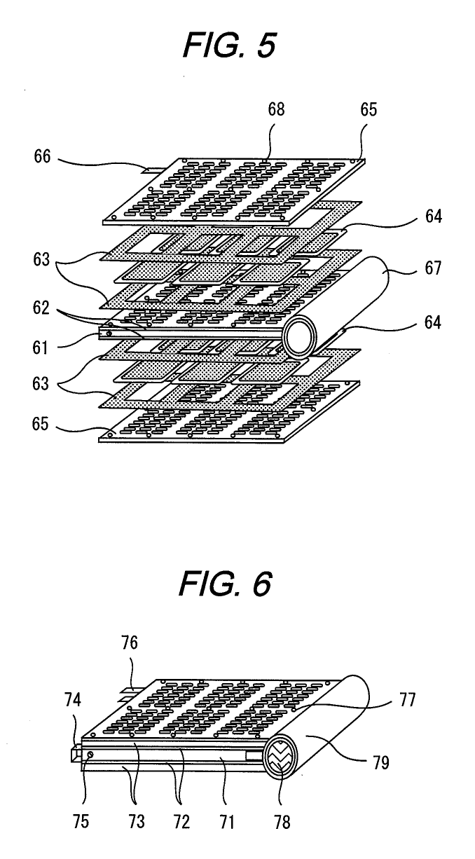

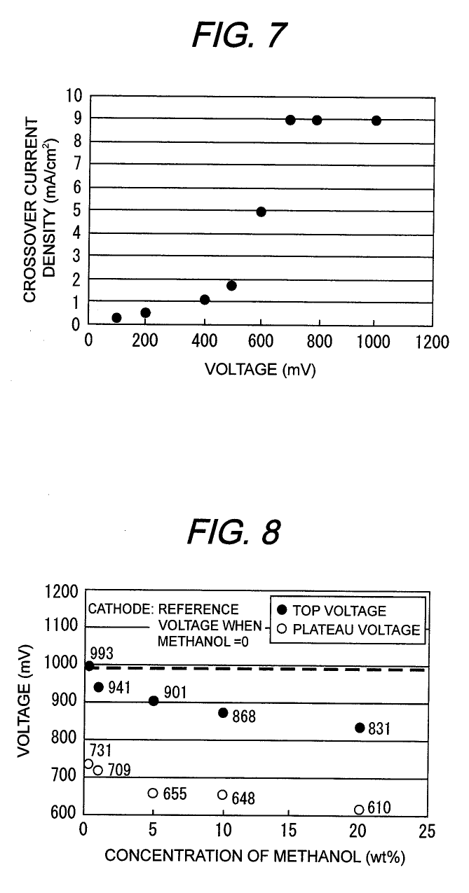

Using the novel crossover loss measuring method of this embodiment, the lifetime of MEA can be evaluated. The degradation of an electrolyte membrane, particularly, an increase of a crossover loss influences the lifetime of MEA greatly. Since the crossover loss can be measured directly according to the measuring method of the embodiment, the lifetime of MEA can be evaluated. This embodiment relates to a device capable of evaluating a lifetime by use of the principle of the novel crossover measuring method. The lifetime evaluation device can be used for DMFC shown in FIGS. 5 and 7. FIG. 5 shows constituent parts. A fuel chamber 61 provided with a cartridge holder 67 is laminated at opposite sides thereof with an anode terminal plate 62, a gasket 63, a diffusion layer-bearing MEA 64, a gasket 63 and a cathode terminal plate 65 in this order, and the laminates are fixed integrally by means of screws 68 so that an in-plane pressurized force becomes substantially uniform. Terminals 66 extend from the anode terminal plate and the cathode terminal plate, respectively, from which electric power is taken out. In FIG. 6, there is shown DMFC wherein the constituent parts of FIG. 5 are laminated and fixed. DMFC has such a structure that a plurality of MEA's are connected in series at opposite sides of a fuel chamber 71 and the series MEA groups on the opposite surfaces are further connected in series by means of a connection terminal 74 wherein electric power is taken out from an output terminal 76. With the case of FIG. 6, MEA's are of 12 series. In FIG. 6, a methanol aqueous solution is fed under pressure from a fuel cartridge 78 by means of a high pressure liquefied gas, a high pressure gas or a spring, and CO₂ formed at the anode is discharged from an exhaust gas port 75. This exhaust gas port 75 has a gas-liquid separation function and a gas is allowed to pass therethrough, but a liquid is not allowed. On the other hand, air serving as an oxidizing agent is fed by diffusion from air diffusion slits of the cathode terminal plate 73 and water formed at the cathode is diffused through the slips and discharged. The fastening method for integration of the cell is not limited to fastening with screws 77, and there may be used a method wherein this cell is inserted into a casing and fastened by a compression force from the casing. The lifetime evaluating device using the novel crossover loss measuring method according to the embodiment may be built in DMFC as shown in FIG. 6 or maybe of the type which contacts DMFC as necessary. The lifetime evaluation device is preferably provided with a function of displaying a lifetime or an alarm function informing the end of life.

Using the novel crossover loss measuring method of this embodiment, defective MEA can be sorted. In the mass production of MEA, a certain number of defectives are produced and one of defective factors resides in a failure of electrolyte membrane. For instance, if electrolyte membranes vary in thickness, defective MEA products are produced wherein the crossover loss becomes great. When using the novel crossover loss measuring method of the embodiment, defectives can be sorted. This embodiment relates to an evaluation device of defective MEA products using the principle of the novel crossover loss measuring method.

The application of the embodiment enables MEA to have high output power. More particularly, after methanol in the cathode catalyst layer is made at or close to 0, electric power is generated, upon which there is no methanol crossover loss, so that output power can be improved. For instance, an inert gas is fed to the cathode side and a methanol aqueous solution is filled at the anode side, under which a voltage is loaded between the anode and the cathode so that the methanol crossovered toward the cathode is oxidized electrochemically so that the methanol in the cathode catalyst layer is made substantially at 0. Thereafter, air or oxygen is fed to the cathode in place of the inert gas to generate electric power. Alternatively, instead of filling the cathode with an inert gas, a given current is loaded to lower an oxygen concentration on the surface of the cathode catalyst layer, after which a voltage is loaded between the anode and the cathode so that the methanol crossovered toward the cathode is oxidized electrochemically to make the methanol in the cathode catalyst layer at 0. Subsequently, air or oxygen is fed to the cathode to generate electric power. According to the process stated above, it is expected that output power is improved correspondingly to a suppression of the methanol crossover loss.

Many factors are involved in the degradation of MEA, one of which is degradation of an electrolyte membrane, particularly, an increase of crossover loss. That is, the crossover loss increases owing to the dissolution of the electrolyte membrane or a structural change in the electrolyte membrane. If the crossover loss can be measured directly, evaluation of lifetime becomes possible.

In the mass production of MEA, a given number of defectives occur. One of factors for the defectives results from defects of electrolyte membrane. For instance, if the electrolyte membranes vary in thickness, there occur defectives of MEA whose crossover loss becomes great. The direct measurement of crossover loss enables such defective products to be sorted.

The invention is illustrated by way of embodiments. The embodiment of the invention should not be construed as limited to the following embodiments.

### FIRST EMBODIMENT

S-PES (ion exchange capacity of 1.3 meq/g) was provided as a membrane. A varnish was prepared by dissolving S-PES (ion exchange capacity of 1.3 meq/g) in dimethylacetamide. The concentration of the solute was set at 30 wt %. The varnish was coated onto a glass sheet by means of an applicator and dried at 80° C. for 1 hour and then at 120° C. for 3 hours in a vacuum dryer, thereby evaporating the dimethylacetamide solvent. Thereafter, the coated film was peeled off from the glass sheet and immersed overnight in a 1M H₂SO₄ aqueous solution and protonated to obtain a single electrolyte membrane of S-PES (ion exchange capacity of 1.3 meq/g). The thus obtained electrolyte membrane was transparent. The thickness of the electrolyte membrane was at 50 μm.

MEA was made in the following way. Platinum-bearing carbon TEC10V50E (amount of supported Pt: 50 wt %), made by Tanaka Kikinzoku Kogyo K.K., was provided as a cathode catalyst and platinum and ruthenium-bearing carbon TEC61V54 (amount of supported Pt: 29 wt %, amount of supported Ru: 23 wt %), made by Tanaka Kikinzoku Kogyo K.K., was provided as an anode catalyst. Water and a 5 wt % Nafion solution, made by Aldrich Corp., were added to these catalysts, followed by mixing and agitating to provide catalyst slurries. The catalyst slurries, respectively, had weight ratios of TEC10V50E: water 5 wt % Nafion solution=1:1:8.46 for the cathode and TEC61V54: water 5 wt % Nafion solution=1:1:7.9 for the anode. These catalyst slurries were each applied onto a teflon sheet by use of an applicator to prepare a cathode catalyst layer and an anode catalyst layer. Thereafter, the cathode catalyst layer and the anode catalyst layer were transferred thermally to an electrolyte membrane using a hot press to provide MEA. The amounts of the catalysts were, respectively, at 1.8 mg of Pt and Ru/cm² for the anode catalyst and 1.2 mg of Pt mg/cm² for the cathode catalyst.

The thus made MEA was assembled in a cell shown in FIG. 4. A nitrogen gas was fed to the cathode side at a flow rate of 200 ml/minute and a methanol aqueous solution having a concentration of 5 wt % was filled at the anode side. Initially, the measurement with the Gotesfeld method was made. A voltage of 0.1-0.8 V was loaded between the anode and the cathode to oxidize the methanol crossovered through the cathode, and a current value passed during the oxidation was measured. The hold time of the respective loaded voltages was set at 10 minutes. The results of the measurement are shown in FIG. 7. As shown in FIG. 7, when a voltage not smaller than 0.7 V is loaded, a current density becomes constant, with its value being at 9 mA/m².

The novel crossover loss measuring method of this embodiment was carried out with respect to this MEA. First, a voltage of 0.8 V was loaded for 10 minutes, followed by feeding air at 200 ml/minute in place of nitrogen gas to measure OCV. The methanol concentrations were set at 0.1, 0.3, 1.5, 10 and 20 wt %, respectively. In FIG. 8, there are shown the top voltage and plateau voltage relative to the respective methanol concentrations. The top and plateau voltages are not stabilized when the methanol concentration is at 0.1 wt %. Although it is presumed that the plateau voltage depends on the methanol concentration because the cathode receives an influence of the methanol crossover, the results reveal that the top voltage at which the methanol concentration in the cathode catalyst layer is at 0 also depends on the methanol concentration. This is for the reason that where the methanol concentration is high, the methanol concentration is not exactly at 0 upon completion of the Gotesfeld method. More particularly, it is considered that where the methanol concentration is high, a methanol aqueous solution is left in the surface or fine pores of carbon used as the catalyst carrier. Methanol is also present in the electrolyte membrane. It is believed that these methanol aqueous solutions instantaneously give an influence upon completion of the Gotesfeld method. In this sense, the top voltage obtained by using a 0.3 wt % methanol aqueous solution whose methanol concentration is diluted to the utmost limit is used as a reference voltage in a state where the methanol in the cathode catalyst layer is substantially at 0.

With an actual cell voltage, the anode potential is influenced by the methanol concentration. More particularly, since the anode potential varies depending on the difference in methanol concentration and thus, a correction is needed therefor. For the correction, the equation (7) can be used. The crossover loss at a methanol concentration of 10 wt % is calculated below. The voltage difference ΔV_{conc.} depending on the difference in methanol concentration between 0.3 wt % and 10 wt % is shown below using the equation (7).

ΔV_{conc.}=E₁₀−E_{0.3}=2.303×(RT/nF) log [a_{CH3OH, 10}/a_{CH3OH, 0.3}]

(wherein E₁₀: a voltage at 10 wt %, E_{0.3}: a voltage at 0.3 wt %, a_{CH3OH, 10}: an activity at 10 wt %, and a_{CH3OH, 0.3}: an activity at 0.3 wt %)

=0.01×log (10/0.3)

=0.015 (V)

=15 (mV)

Accordingly, the crossover loss at a methanol concentration of 10 wt % can be calculated by adding a top voltage of 993 mV at a methanol concentration of 0 in the cathode catalyst layer measured at a methanol concentration of 0.3 wt % to a voltage difference of 15 mV depending on the difference in the methanol concentration, and subtracting a plateau voltage of 648 mV at a methanol concentration of 10 wt %.

ΔV_{crossover loss}=E_{0.3}^{t}−E₁₀^{p}+ΔV_{conc.}=993−648+15=360 mV

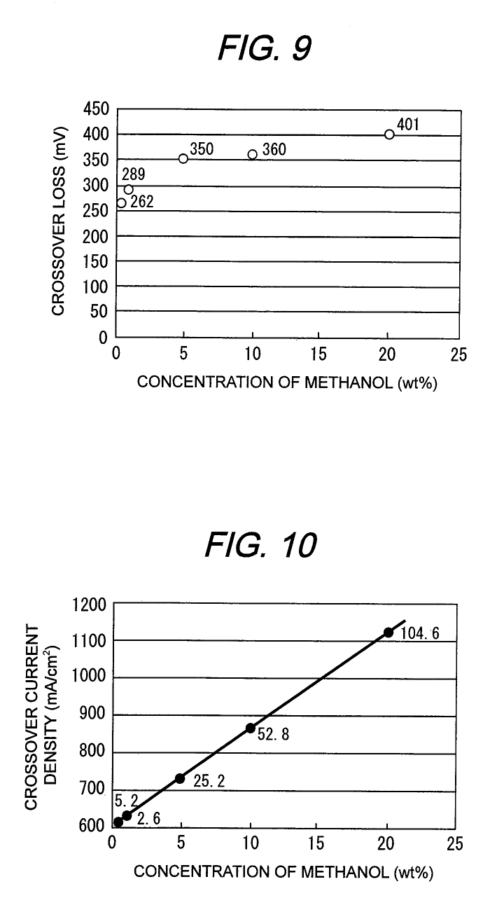

Likewise, the crossover losses at 0.3, 1, 5 and 20 wt % are calculated by using a top voltage at 0.3 wt % that is a voltage at a methanol concentration of 0 in the cathode catalyst layer and correcting it with respect to the methanol concentration, with the results shown in FIG. 9.

### Comparative Example 1

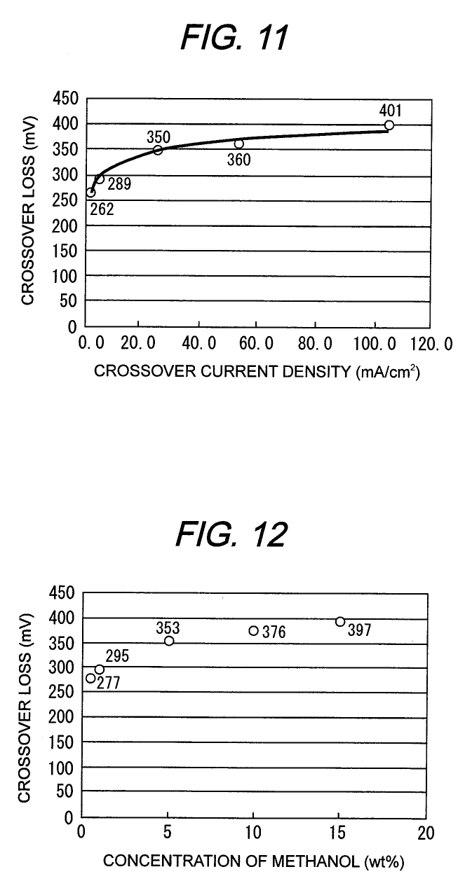

MEA was made under the same conditions as in the First Embodiment. The MEA was subjected to measurement of a crossover current density by use of the Gotesfeld method that is a conventional technique of measuring an amount of crossovered methanol. The measuring conditions were such that nitrogen gas was fed to the cathode at 200 ml/minute and a voltage of 0.8 V was loaded for 10 minutes. In FIG. 10, there are shown the results of the measurement where the methanol concentration is indicated in abscissa and the crossover current density is indicated in ordinate. The crossover current density is in proportion to the methanol concentration. FIG. 11 shows the relation between the crossover loss measured in the First Embodiment and the crossover current density measured in Comparative Example 1. It will be found that the relation is non-linear as shown in FIG. 11. More particularly, it has been found according to the measuring method of this embodiment that if the crossover current density that has been used as a measure for the amount of crossovered methanol up to now is reduced to half, the crossover loss does not reduced to half.

### SECOND EMBODIMENT

Nafion 112 (with a thickness of about 50 μm), made by Du Pont Kabushiki Kaisha, was used as an electrolyte membrane. In the same conditions and procedure as in the First Embodiment, MEA's were made. These MEA's were subjected to measurement of a crossover loss according to the novel crossover measuring method of this embodiment. FIG. 12 shows a crossover loss relative to a methanol concentration. The relation between the crossover loss and the methanol concentration became non-linear.

### Comparative Example 2

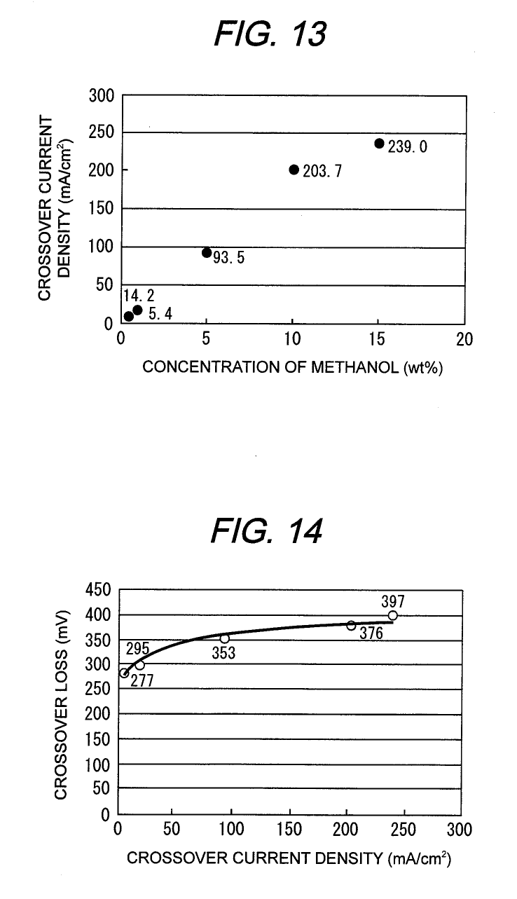

The MEA of the Second Embodiment was subjected to measurement of a crossover current density according to the Gotesfeld method. The results are shown in a figure. As is particularly shown in FIG. 13, the linear relationship is obtained when using the Gotesfeld method. FIG. 12 is directed to the relation between the crossover loss measured in the Second Embodiment and the crossover current density measured in Comparative Example 2. As shown in FIG. 14, a nonlinear relation is obtained. It has been confirmed that if the type of electrolyte membrane is changed, the relation between the crossover current density and the crossover loss is nonlinear.

### THIRD EMBODIMENT

MEA was made under the same conditions as in the First Embodiment. This MEA was assembled in a cell shown in FIG. 4. The temperature of the cell was set at 70° C. Nitrogen gas was fed to the cathode and hydrogen gas was fed to the anode each at 70° C. after humidification. In this condition, a voltage of 0.8 V was loaded between the anode and the cathode for 10 minutes. A running current density was at 0.3 mA/cm². Thereafter, air was fed to the cathode in place of the nitrogen gas, followed by measurement of a voltage. As a result, a top voltage was 1100 mv, and a plateau voltage was 1050 mv. As a result, a hydrogen crossover loss obtained was at 50 mV.

1. (canceled)

2. A method for measuring a methanol crossover loss of a membrane electrode assembly which comprises a cathode catalyst layer reducing an oxidative gas and an anode catalyst layer oxidizing a methanol aqueous solution, a proton conductive solid polymer electrolyte membrane layer arranged therebetween, comprising measuring a difference between a voltage at which said cathode catalyst layer is free of an influence of the methanol crossover and a voltage at which said cathode catalyst layer receives an influence of the methanol crossover.

3. A method for measuring a crossover loss of a membrane electrode assembly which comprises a cathode catalyst layer reducing an oxidative gas and an anode catalyst layer oxidizing a methanol aqueous solution, a proton conductive solid polymer electrolyte membrane layer arranged therebetween, comprising measuring a voltage change of the membrane electrode assembly, when feeding air or oxygen to the cathode side after oxidizing electrochemically the methanol crossovered from the anode catalyst layer toward the cathode catalyst layer by loading a voltage between the anode and the cathode in such state where the methanol aqueous solution is filled at an anode side and an inert gas is filled at a cathode side.

4. The method according to claim 3, characterized in that the crossover loss is measured from a difference between a top voltage and a plateau voltage after feeding air or oxygen to the cathode side is started.

5. The method according to claim 3, characterized in that the loaded voltage is 0.7 to 0.9 V.

6. The method according to claim 3, characterized in that the time of holding the loaded voltage is 10 seconds or more.

7. An apparatus for evaluating a membrane electrode assembly for a methanol fuel cell which comprises a device capable of feeding an inert gas and air or oxygen to a cathode side by switching from one to another, a device capable of feeding a fuel to an anode side, and a device of capable of loading a voltage between an anode and a cathode, comprising measuring the voltage change when air or oxygen displacing the inert gas is fed to the cathode side, after the inert gas is fed to the cathode side and the voltage is loaded between the anode and the cathode for oxidizing electrochemically a methanol which is the fuel crossovered toward the cathode side.

8. (canceled)

9. A method for measuring a crossover loss of hydrogen of a membrane electrode assembly comprising a cathode catalyst layer reducing an oxidative gas and an anode catalyst layer oxidizing hydrogen, a proton conductive solid polymer electrolyte membrane layer arranged therebetween, comprising measuring a difference between a voltage at which the cathode catalyst layer is free of an influence of hydrogen crossover and a voltage at which the cathode catalyst layer receives an influence of the hydrogen crossover.

10. A method, comprising measuring a voltage change of a membrane electrode assembly comprising a cathode catalyst layer reducing an oxidative gas and an anode catalyst layer oxidizing hydrogen, a proton conductive solid polymer electrolyte membrane layer arranged therebetween, when air or oxygen is fed to the cathode side, after oxidizing electrochemically hydrogen crossovered from the anode catalyst layer toward the cathode catalyst layer by loading a voltage between the anode and the cathode in such state where a hydrogen gas is filled at an anode side and an inert gas is filled at a cathode side.

11. The method according to claim 10, characterized in that the crossover loss is measured from a difference between a top voltage and a plateau voltage after feeding air or oxygen to the cathode side is started.

12. The method according to claim 10, characterized in that the loaded voltage is 0.01 to 0.9 V.

13. The method according to claim 10, characterized in that the time of holding the loaded voltage is 10 seconds or more.

14. An apparatus for evaluating a membrane electrode assembly for PEFC which comprises a device capable of feeding, to a cathode side, an inert gas and air or oxygen by switching from one to another, a device capable of feeding a fuel to an anode side, and a device of capable of loading a voltage between an anode and a cathode, comprising measuring a voltage change of the membrane electrode assembly when air or oxygen is fed to the cathode side in place of the inert gas after the inert gas is fed to the cathode side to oxidize electrochemically hydrogen crossovered toward the cathode side.

15. A method comprising measuring a voltage of a membrane electrode assembly for the methanol fuel cell which comprises a cathode catalyst layer reducing an oxidative gas and an anode catalyst layer oxidizing a methanol aqueous solution, a proton conductive solid polymer electrolyte membrane layer arranged therebetween after loading a voltage for oxidizing electrochemically methanol crossovered from the anode toward the cathode after loading a current to the membrane electrode assembly.

16. An apparatus for evaluating a lifetime of a membrane electrode assembly for methanol fuel cell, comprising a device capable of feeding an inert gas, and air or oxygen to a cathode side by switching from one to the other, a device capable of feeding a fuel to an anode side and a device capable of loading a voltage between an anode and a cathode, wherein a crossover loss of the membrane electrode assembly is measured when air or oxygen is fed to the cathode side, after a methanol which is the fuel crossovered toward the cathode side is oxidized electrochemically by loading a voltage between the anode and the cathode when the inert gas is fed to the cathode side, or by loading the voltage between the anode and the cathode after an electric current is sent therebetween.

17. An apparatus for sorting defectives of membrane electrode assemblies for methanol fuel cell, comprising a device capable of feeding an inert and air or oxygen to a cathode side by switching from one to the other, a device capable of feeding a fuel to an anode side and a device capable of loading a voltage between an anode and a cathode wherein a crossover loss of said membrane electrode assemblies is measured when air or oxygen is fed to the cathode side, after a methanol which is the fuel crossovered toward the cathode side is oxidized electrochemically by loading a voltage between the anode and the cathode when the inert gas is fed to the cathode side, or by loading the voltage between the anode and the cathode after an electric current is loaded therebetween.

18. A methanol fuel cell containing a membrane electrode assembly comprising a cathode catalyst layer reducing an oxidative gas and an anode catalyst layer oxidizing a methanol aqueous solution, a proton conductive solid polymer electrolyte membrane layer arranged therebetween, wherein electricity is generated in a state where the cathode catalyst layer is free of an influence of methanol.
